(19) United States
(12) Patent Application Publication
(10) Pub. No.: US 2025/0244349 A1
(43) Pub. Date: Jul. 31, 2025

(54) AUTOMATIC ANALYSIS APPARATUS AND CONTROL METHOD

(71) Applicant: Canon Medical Systems Corporation, Otawara-shi (JP)

(72) Inventors: Takafumi FUJIWARA, Nasushiobara (JP); Takahiro OMORI, Otawara (JP); Takeshi KINPARA, Utsunomiya (JP); Hideto KOJIMA, Nikko (JP); Tomoaki KURANO, Nasushiobara (JP); Yoshifumi YAMAGATA, Sakura (JP)

(73) Assignee: Canon Medical Systems Corporation, Otawara-shi (JP)

(21) Appl. No.: 19/041,281

(22) Filed: Jan. 30, 2025

(30) Foreign Application Priority Data
Jan. 30, 2024 (JP) 2024-011788
Jan. 27, 2025 (JP) 2025-011214

(51) Int. Cl. G01N 35/02; G01N 35/00; G01N 35/04; G01N 35/10

(52) U.S. Cl. CPC G01N 35/025; G01N 35/0098; G01N 35/1002; G01N 35/1065; G01N 2035/0446; G01N 2035/0453

(57) ABSTRACT

According to one embodiment, an automatic analysis apparatus includes a reagent storage and a reagent container arm. The reagent storage includes an outer circumferential table on which a plurality of reagent containers are loaded and an inner circumferential table located inside the outer circumferential table and on which a plurality of reagent containers are loaded. The reagent container arm conveys a reagent container to the inner circumferential table through between the reagent containers loaded on the outer circumferential table.

### CROSS-REFERENCE TO RELATED APPLICATIONS

This application is based upon and claims the benefit of priority from Japanese Patent Applications No. 2024-011788, filed Jan. 30, 2024; and NO. 2025-011214,filed Jan. 27, 2025; the entire contents of all of which are incorporated herein by reference.

### FIELD

Embodiments described herein relate generally to an automatic analysis apparatus and a control method.

### BACKGROUND

An automatic analysis apparatus is an apparatus that automatically analyzes a sample (for example, blood, urine) to measure the concentrations of various components in the sample. The automatic analysis apparatus performs various measurements based on the amount of transmitted light or scattered light obtained by mixing a reagent with the sample and irradiating the mixed solution with light.

A reagent storage of the automatic analysis apparatus holds a plurality of reagent containers storing reagents. A kind of reagent storage includes an outer circumferential table and an inner circumferential table that rotate independently of each other. In the automatic analysis apparatus including such a reagent storage, there is known a technique of loading a reagent container lifted by a robot arm onto the outer circumferential table or the inner circumferential table from above the reagent storage.

However, in the above technique, it is necessary to provide an inlet corresponding to the outer circumferential table and an inlet corresponding to the inner circumferential table with respect to the reagent storage so that the robot arm can access the outer circumferential table and the inner circumferential table. Furthermore, it is necessary to control the robot arm to be able to access the two inlets. Therefore, the above technique complicates the structure of the automatic analysis apparatus, and causes problems such as an increase in cost.

### BRIEF DESCRIPTION OF THE DRAWINGS

FIG. 1 is a block diagram illustrating a configuration example of an automatic analysis apparatus according to a first embodiment.

FIG. 2 is a perspective view illustrating a configuration example of an analysis mechanism according to the first embodiment.

FIG. 3 is a top view illustrating a configuration example of a first reagent storage according to the first embodiment.

FIG. 4 is a three-view drawing illustrating a configuration example of each table according to the first embodiment.

FIG. 5 is a three-view drawing illustrating a configuration example of a reagent container according to the first embodiment.

FIG. 6 is a view illustrating an example in which the reagent container according to the first embodiment is conveyed to an inner circumferential table.

FIG. 7 is a view illustrating an example in which the reagent container according to the first embodiment is conveyed from the inner circumferential table.

FIG. 8 is a view illustrating a configuration example of reagent containers and rails according to a modified example of the first embodiment.

FIG. 9 is a view illustrating a configuration example of each table and a reagent container according to a second embodiment.

FIG. 10 is a view illustrating an example in which the reagent container according to the second embodiment is conveyed to each table.

FIG. 11 is a view illustrating a configuration example of each table and each reagent container according to a third embodiment.

FIG. 12 is a view illustrating an example in which each reagent container is conveyed to each table according to the third embodiment.

FIG. 13 is a top view illustrating a rotation control example of each table according to each embodiment.

### DETAILED DESCRIPTION

In general, according to one embodiment, an automatic analysis apparatus includes a reagent storage and a reagent container arm. The reagent storage includes an outer circumferential table on which a plurality of reagent containers are loaded and an inner circumferential table located inside the outer circumferential table and on which a plurality of reagent containers are loaded. The reagent container arm conveys a reagent container to the inner circumferential table through between the reagent containers loaded on the outer circumferential table.

Hereinafter, each embodiment will be described with reference to the drawings. In the following embodiments, portions denoted by the same reference numerals perform similar operations, and redundant description will be appropriately omitted.

### First Embodiment

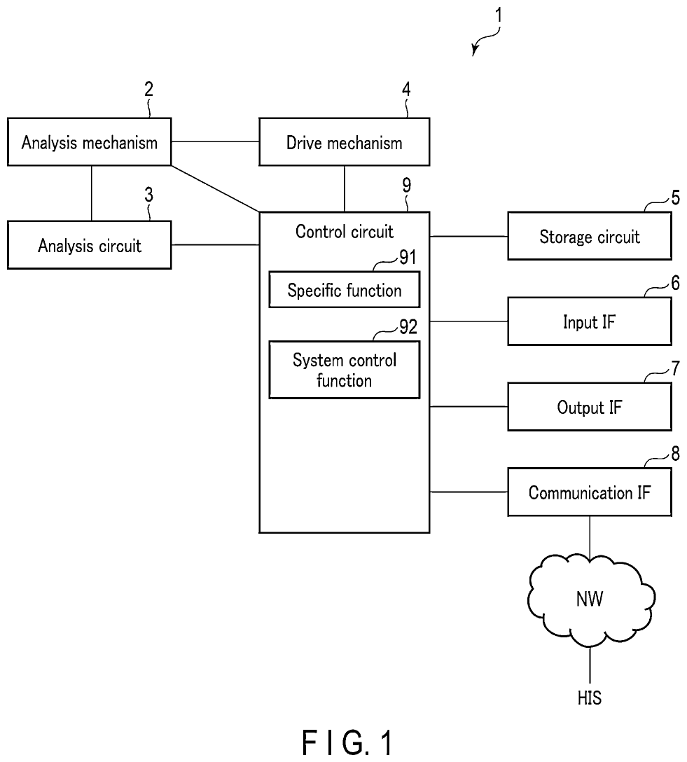

FIG. 1 is a block diagram illustrating the configuration example of an automatic analysis apparatus 1 according to a first embodiment. The automatic analysis apparatus 1 includes an analysis mechanism 2, an analysis circuit 3, a drive mechanism 4, a storage circuit 5, an input IF 6, an output IF 7, a communication IF 8, and a control circuit 9.

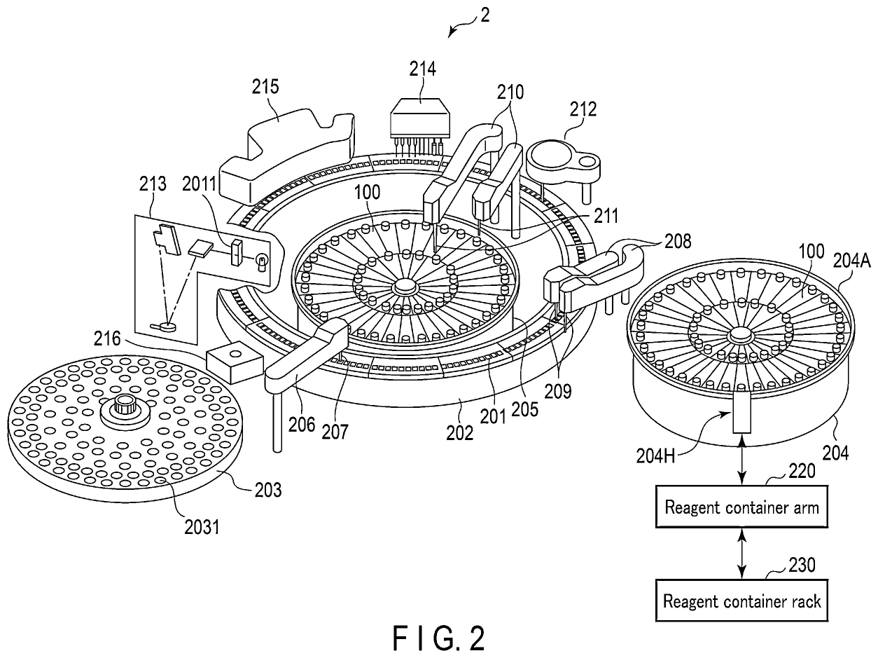

The analysis mechanism 2 is a mechanism that automatically analyzes a sample (for example, blood, urine) to measure the concentrations of various components in the sample. The analysis mechanism 2 mixes a reagent used for a predetermined test item with a test sample or a standard solution. The analysis mechanism 2 measures the optical physical property value of the mixed solution based on the amount of transmitted light or scattered light obtained by irradiating the mixed solution with light. The analysis mechanism 2 generates, as a measurement result, test data related to the mixed solution of the test sample and the reagent, and generates standard data related to the mixed solution of the standard solution and the reagent. The analysis mechanism 2 is an example of an analysis portion (see FIG. 2).

The analysis circuit 3 is a circuit that analyzes the test data and the standard data generated by the analysis mechanism 2 and generates analysis data and calibration data, respectively. The analysis circuit 3 includes at least one processor. The analysis circuit 3 reads an analysis program from the storage circuit 5, and analyzes the test data and the standard data according to the read analysis program. The analysis circuit 3 is an example of an analysis portion.

The drive mechanism 4 is a mechanism that drives the analysis mechanism 2 under the control of the control circuit 9. The drive mechanism 4 is realized by a gear, a stepping motor, a belt conveyor, a lead screw, and the like. The drive mechanism 4 is an example of a drive portion.

The storage circuit 5 is a circuit that stores various data. The storage circuit 5 may be a storage medium (for example, magnetic storage medium, electromagnetic storage medium, optical storage medium, semiconductor memory) readable by a processor, or may be a drive apparatus that reads and writes data from and to the storage medium. The storage circuit 5 is an example of a storage portion.

The storage circuit 5 stores an analysis program executed by the analysis circuit 3 and a control program executed by the control circuit 9. The storage circuit 5 stores analysis data generated by the analysis circuit 3 for each test sample, and stores calibration data generated by the analysis circuit 3 for each test item. The storage circuit 5 stores an examination order input by an operator via the input IF 6, and stores the examination order received by the communication IF 8 via a hospital network NW.

The input IF 6 is an interface that receives various input operations. The input IF 6 is realized by a mouse, a keyboard, a touch pad, a touch panel, or the like. The input IF 6 may be a processing circuit that receives an electric signal corresponding to a predetermined operation instruction from an external input device provided separately from the automatic analysis apparatus 1 and outputs the electric signal to the control circuit 9. The input IF 6 converts an input operation received from the operator into an electric signal and outputs the electric signal to the control circuit 9. The input IF 6 is an example of an input portion.

The output IF 7 is an interface that outputs various data. The output IF 7 outputs various data based on an output signal supplied from the control circuit 9. The output IF 7 may be a touch pad or a touch panel that also functions as the input IF 6. The output IF 7 is realized by a display device, a printing device, an acoustic device, or the like. The output IF 7 is an example of an output portion.

The display device may be a CRT display, a liquid crystal display, an organic EL display, an LED display, or a plasma display. The display device may be a processing circuit that converts data related to a display target into a video signal and outputs the video signal to the outside. The display device is an example of a display portion.

The printing device may be a printer. The printing device may be a processing circuit that outputs data related to a printing target to the outside. The printing device is an example of a printing portion.

The acoustic device may be a speaker. The acoustic device may be a processing circuit that outputs an audio signal to the outside. The audio device is an example of an audio portion.

The communication IF 8 is an interface that communicates various data. The communication IF 8 communicates with a hospital information system (HIS) via the hospital network NW. The communication IF 8 may communicate with the hospital information system via a laboratory information system (LIS) connected to the hospital network NW. The communication IF 8 is an example of a communication portion.

The control circuit 9 is a circuit that controls the entire operation of the automatic analysis apparatus 1. The control circuit 9 includes at least one processor. The processor means a circuit such as a central processing unit (CPU), a graphics processing unit (GPU), an application specific integrated circuit (ASIC), or a programmable logic device (for example, a simple programmable logic device (SPLD), a complex programmable logic device (CPLD), or a field programmable gate array (FPGA). In a case where the processor is a CPU, the CPU reads and executes the control program stored in the storage circuit 5 to realize each function. In a case where the processor is an ASIC, each function is directly incorporated into a circuit of the ASIC as a logic circuit. The processor may be configured as a single circuit, or may be configured by combining a plurality of independent circuits with each other. The control circuit 9 realizes a specific function 91 and a system control function 92. The control circuit 9 is an example of a control portion.

The specific function 91 is a function of specifying various data. For example, the specific function 91 specifies a space in which the reagent container can be loaded in the reagent storage of the analysis mechanism 2. The specific function 91 may specify a distance from an opening formed in the reagent storage to the specified space. The specific function 91 is an example of the specifying portion.

The system control function 92 is a function that controls the entire operation of the automatic analysis apparatus 1. For example, the system control function 92 controls the operation of the drive mechanism 4 so as to measure a sample according to a predetermined inspection item. The system control function 92 controls the operation of the analysis circuit 3 so as to analyze the test data and the standard data generated by the analysis mechanism 2. The system control function 92 may control the reagent storage of the analysis mechanism 2 and the robot arm. The system control function 92 is an example of a system control portion.

FIG. 2 is a perspective view illustrating the configuration example of an analysis mechanism 2 according to a first embodiment. The analysis mechanism 2 includes a reaction disk 201, a thermostatic bath 202, a sample disk 203, a first reagent storage 204, a second reagent storage 205, a sample dispensing arm 206, a sample dispensing probe 207, a first reagent dispensing arm 208, a first reagent dispensing probe 209, a second reagent dispensing arm 210, a second reagent dispensing probe 211, an electrode unit 212, a photometric unit 213, a cleaning unit 214, a stirring unit 215, a probe cleaning unit 216, a reagent container arm 220, and a reagent container rack 230.

The reaction disk 201 is a disk that disposes and holds a plurality of reaction containers 2011 in an annular shape. The reaction disk 201 moves the plurality of reaction containers 2011 along a predetermined path under the control of the drive mechanism 4. The reaction disk 201 rotates by a predetermined angle and stops at predetermined time intervals (for example, 4.5 s, 9.0 s).

The thermostatic bath 202 is a bath that maintains the plurality of reaction containers 2011 at a constant temperature. The thermostatic bath 202 stores a heating medium set at a predetermined temperature. The thermostatic bath 202 maintains the plurality of reaction containers 2011 at a constant temperature by immersing the plurality of reaction containers 2011 in the heat medium.

The sample disk 203 is a disk that disposes and holds a plurality of sample containers 2031 in an annular shape. The sample disk 203 moves the plurality of sample containers 2031 along a predetermined path under the control of the drive mechanism 4. The sample disk 203 is disposed adjacent to the reaction disk 201. The sample disk 203 may be covered from above with a detachable cover.

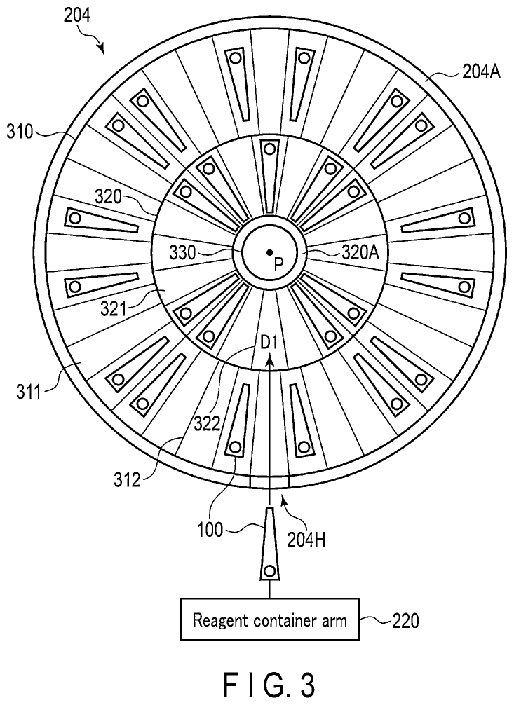

The first reagent storage 204 is a storage chamber that disposes and holds a plurality of reagent containers 100 in an annular shape. The first reagent storage 204 moves the plurality of reagent containers 100 along a predetermined path under the control of the drive mechanism 4. The first reagent storage 204 is disposed adjacent to the reaction disk 201. The first reagent storage 204 may be covered from above with a detachable cover (see FIG. 3).

The first reagent storage 204 includes a housing 204A. For example, the housing 204A is made of a material such as aluminum having excellent thermal conductivity. A rectangular opening 204H is formed at a predetermined position of the housing 204A. The reagent container 100 is conveyed between the outside and the inside of the first reagent storage 204 through the opening 204H.

The reagent container arm 220 is a robot arm that conveys the reagent container 100. The reagent container arm 220 holds the reagent container 100 and conveys the held reagent container 100 under the control of the drive mechanism 4. For example, the reagent container arm 220 holds the reagent container 100 placed on the reagent container rack 230, and conveys the held reagent container 100 into the first reagent storage 204 through the opening 204H. Meanwhile, the reagent container arm 220 holds the reagent container 100 placed on the first reagent storage 204, and conveys the held reagent container 100 to the outside of the first reagent storage 204 (for example, the reagent container rack 230) through the opening 204H. The reagent container arm 220 is disposed adjacent to the first reagent storage 204. The reagent container arm 220 is an example of a conveyance portion.

The reagent container rack 230 is a rack on which a plurality of reagent containers 100 are placed. For example, the operator manually places the reagent container 100 on the reagent container rack 230. The reagent container rack 230 is disposed adjacent to the first reagent storage 204 or the reagent container arm 220. The reagent container rack 230 is an example of a placement portion.

The second reagent storage 205 is a storage chamber that disposes and holds a plurality of reagent containers 100 in an annular shape. The second reagent storage 205 moves the plurality of reagent containers 100 along a predetermined path under the control of the drive mechanism 4. The second reagent storage 205 is disposed in the reaction disk 201. The second reagent storage 205 may be covered from above with a detachable cover.

The sample dispensing arm 206 is a robot arm that holds the sample dispensing probe 207 at one end. The sample dispensing arm 206 moves in a vertical direction and rotates in a horizontal direction under the control of the drive mechanism 4. The sample dispensing arm 206 is disposed between the reaction disk 201 and the sample disk 203.

The sample dispensing probe 207 is a probe for dispensing a sample into the reaction container 2011. The sample dispensing probe 207 moves in the same direction as that of the sample dispensing arm 206. The sample dispensing probe 207 sucks a sample from the sample container 2031 and discharges the sucked sample to the reaction container 2011 under the control of the drive mechanism 4. The sample dispensing probe 207 is cleaned in the probe cleaning unit 216 under the control of the drive mechanism 4.

The first reagent dispensing arm 208 is a robot arm that holds the first reagent dispensing probe 209 at one end. The first reagent dispensing arm 208 moves in a vertical direction and rotates in a horizontal direction under the control of the drive mechanism 4. The first reagent dispensing arm 208 is disposed between the reaction disk 201 and the first reagent storage 204.

The first reagent dispensing probe 209 is a probe for dispensing a reagent into the reaction container 2011. The first reagent dispensing probe 209 moves in the same direction as that of the first reagent dispensing arm 208. The first reagent dispensing probe 209 sucks a reagent from the reagent container 100 of the first reagent storage 204 and discharges the sucked reagent to the reaction container 2011 under the control of the drive mechanism 4.

The second reagent dispensing arm 210 is a robot arm that holds the second reagent dispensing probe 211 at one end. The second reagent dispensing arm 210 moves in a vertical direction and rotates in a horizontal direction under the control of the drive mechanism 4. The second reagent dispensing arm 210 is disposed between the reaction disk 201 and the second reagent storage 205.

The second reagent dispensing probe 211 is a probe for dispensing a reagent into the reaction container 2011. The second reagent dispensing probe 211 moves in the same direction as that of the second reagent dispensing arm 210. The second reagent dispensing probe 211 sucks a reagent from the reagent container 100 of the second reagent storage 205 and discharges the sucked reagent to the reaction container 2011 under the control of the drive mechanism 4.

The electrode unit 212 is a unit that electrically measures the electrolyte concentration of the mixed solution stored in the reaction container 2011. The electrode unit 212 is disposed adjacent to the reaction disk 201. The electrode unit 212 includes an ion selective electrode (ISE) and a reference electrode (RE). The electrode unit 212 measures a potential between the ion selective electrode and the reference electrode for the mixed solution containing ions to be measured under the control of the drive mechanism 4. The electrode unit 212 generates test data or standard data representing the measured potential. The electrode unit 212 outputs the generated test data or standard data to the analysis circuit 3.

The photometric unit 213 is a unit that optically measures the concentration of a predetermined component of the mixed solution stored in the reaction container 2011. The photometric unit 213 is disposed adjacent to the reaction disk 201. The photometric unit 213 includes a light source and a photodetector. The photometric unit 213 irradiates the reaction container 2011 with light from the light source under the control of the drive mechanism 4, and causes the photodetector to detect the light transmitted through the reaction container 2011.

First, the photodetector detects light transmitted through the mixed solution of the test sample and the reagent in the reaction container 2011. The photodetector generates test data represented by transmitted light intensity, scattered light intensity, and the like based on the amount of the detected light. Secondly, the photodetector detects light transmitted through the mixed solution of the standard solution and the reagent in the reaction container 2011. The photodetector generates standard data represented by transmitted light intensity, scattered light intensity, and the like based on the amount of the detected light. The photodetector outputs the generated test data or standard data to the analysis circuit 3.

The cleaning unit 214 is a unit for cleaning the inside of the reaction container 2011. The cleaning unit 214 is disposed adjacent to the reaction disk 201. The cleaning unit 214 includes a cleaning solution supply pump and a cleaning nozzle. The cleaning unit 214 supplies the cleaning solution from the cleaning solution supply pump to the reaction container 2011 under the control of the drive mechanism 4. The cleaning unit 214 causes the cleaning nozzle to suck the mixed solution, the cleaning solution, and the like from the reaction container 2011 under the control of the drive mechanism 4.

The stirring unit 215 is a unit that stirs the mixed solution stored in the reaction container 2011. The stirring unit 215 is disposed adjacent to the reaction disk 201. The stirring unit 215 includes a stirrer. The stirring unit 215 causes the stirrer to stir the mixed solution stored in the reaction container 2011 under the control of the drive mechanism 4.

The probe cleaning unit 216 is a unit that cleans the sample dispensing probe 207. The probe cleaning unit 216 is disposed adjacent to the reaction disk 201. The probe cleaning unit 216 cleans the sample dispensing probe 207 after discharging the sample to the reaction container 2011 under the control of the drive mechanism 4.

FIG. 3 is a top view illustrating the configuration example of the first reagent storage 204 according to the first embodiment. The first reagent storage 204 includes a housing 204A formed with an opening 204H into which the reagent container 100 can be inserted, adjacent to one end of the outer circumferential table 310. The inner circumferential table 320 includes an inner wall 320A at one end not adjacent to the outer circumferential table 310. A shaft 330 is disposed in the inner wall 320A. The center of the shaft 330 corresponds to a rotation center P.

The first reagent storage 204 includes an outer circumferential table 310 on which a plurality of reagent containers 100 are loaded and an inner circumferential table 320 on which a plurality of reagent containers 100 are loaded. The outer circumferential table 310 and the inner circumferential table 320 rotate independently of each other around the rotation center P under the control of the drive mechanism 4. The outer circumferential table 310 is an example of an outer circumferential loading portion. The inner circumferential table 320 is an example of an inner circumferential loading portion.

The outer circumferential table 310 has each space 311 in which each of the plurality of reagent containers 100 is loaded. A pair of partition walls 312 extending in the radial direction of the outer circumferential table 310 are disposed in each space 311. The reagent container 100 loaded in each space 311 is supported by the pair of partition walls 312. The partition wall 312 can prevent the reagent container 100 from falling due to a centrifugal force accompanying the rotation of the outer circumferential table 310. The partition wall 312 is an example of a guide portion.

The inner circumferential table 320 is located inside the outer circumferential table 310, and has each space 321 in which each of the plurality of reagent containers 100 is loaded. A pair of partition walls 322 extending in the radial direction of the inner circumferential table 320 are disposed in each space 321. The reagent container 100 loaded in each space 321 is supported by the pair of partition walls 322. The partition wall 322 can prevent the reagent container 100 from falling due to a centrifugal force accompanying the rotation of the inner circumferential table 320. The partition wall 322 is an example of a guide portion.

The reagent container arm 220 conveys the held reagent container 100 along a direction D1 from the opening 204H toward the rotation center P. That is, the reagent container arm 220 conveys the reagent container 100 to the inner circumferential table 320 through the opening 204H and the outer circumferential table 310. At this time, the reagent container arm 220 conveys the reagent container 100 via the partition walls 312 and 322. Spaces 311 and 321 (empty spaces) in which no other reagent container 100 is loaded are located in the conveyance path of the reagent container 100 along the direction D1. The reagent container arm 220 conveys the reagent container 100 to the empty space 321 of the inner circumferential table 320 through the empty space 311 (alternatively, between the plurality of reagent containers 100 loaded on the outer circumferential table 310) of the outer circumferential table 310.

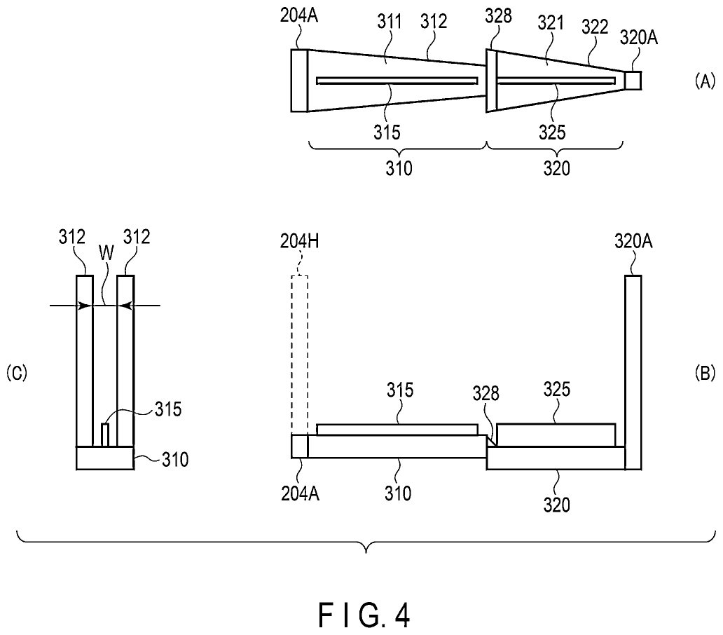

FIG. 4 is a three-view drawing illustrating the configuration example of each table according to the first embodiment. FIG. 4 illustrates spaces 311 and 321 located in the conveyance path of the reagent container 100 along the direction D1 of FIG. 3. FIG. 4 (A) is a top view of the outer circumferential table 310 and the inner circumferential table 320. FIG. 4 (B) is a front view of the outer circumferential table 310 and the inner circumferential table 320. FIG. 4 (C) is a left side view of the outer circumferential table 310.

As illustrated in FIG. 4 (A), the outer circumferential table 310 includes an outer circumferential rail 315 extending in the radial direction of the outer circumferential table 310. The outer circumferential rail 315 has a rectangular cross section and is disposed so as to bisect the space 311. The inner circumferential table 320 includes an inner circumferential rail 325 extending in the radial direction of the inner circumferential table 320. The inner circumferential rail 325 has a rectangular cross section and is disposed so as to bisect the space 321. The outer circumferential rail 315 and the inner circumferential rail 325 are located on a straight line. The outer circumferential rail 315 and the inner circumferential rail 325 are an example of a guide portion.

The outer circumferential rail 315 may be disposed in each space 311 of the outer circumferential table 310. The inner circumferential rail 325 may be disposed in each space 321 of the inner circumferential table 320.

The inner circumferential table 320 includes an inclined member 328 at one end adjacent to the outer circumferential table 310. The inclined member 328 includes an inclined surface inclined from the upper surface of the outer circumferential table 310 to the upper surface of the inner circumferential table 320.

As illustrated in FIG. 4 (B), the housing 204A is disposed adjacent to one end of the outer circumferential table 310. An opening 204H is located above the housing 204A. The inner wall 320A is disposed adjacent to one end of the inner circumferential table 320.

The upper surface of the outer circumferential table 310 is at a higher position in the vertical direction than that of the upper surface of the inner circumferential table 320. The upper surface of the outer circumferential table 310 and the upper surface of the inner circumferential table 320 are connected by the inclined member 328. That is, the inclined member 328 is disposed so as to eliminate a step between the upper surface of the outer circumferential table 310 and the upper surface of the inner circumferential table 320.

The upper surface of the outer circumferential rail 315 is located at the same height as that of the upper surface of the inner circumferential rail 325. That is, the height of the outer circumferential rail 315 is shorter than the height of the inner circumferential rail 325. For example, the height of the outer circumferential rail 315 is formed to be ½ times the height of the inner circumferential rail 325.

As illustrated in FIG. 4 (C), a pair of partition walls 312 are disposed at both ends of the outer circumferential table 310. A lateral width W between the pair of partition walls 312 gradually narrows in a depth direction (direction from the outer circumferential table 310 toward the inner circumferential table 320). The lateral width W is the narrowest at a position where the pair of partition walls 312 are adjacent to the inner circumferential table 320. The narrowest lateral width W is larger than the largest lateral width of the reagent container 100. Therefore, the reagent container 100 is conveyed to the inner circumferential table 320 through between the pair of partition walls 312.

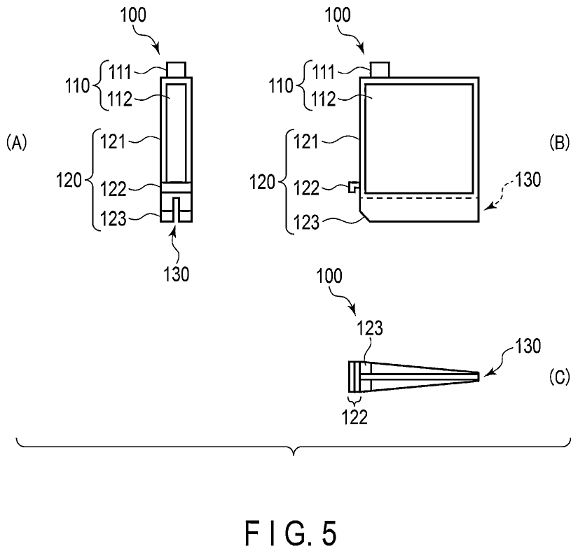

FIG. 5 is a three-view drawing illustrating the configuration example of the reagent container 100 according to the first embodiment. FIG. 5 (A) is a left side view of the reagent container 100. FIG. 5 (B) is a front view of the reagent container 100. FIG. 5 (C) is a bottom view of the reagent container 100.

The reagent container 100 has a shape (tapered shape) whose lateral width gradually narrows from the left side surface toward the right side surface. That is, the horizontal cross section of the reagent container 100 has a wedge shape (trapezoid). The reagent container 100 includes a reagent bottle 110 and an adapter 120. The reagent bottle 110 includes an opening member 111 and a main body 112. The adapter 120 includes a frame body 121, an engaging claw 122, and a cutout surface 123. A rectangular fitting groove 130 is formed in the lower surface of the adapter 120. The horizontal cross section of the reagent container 100 may have a rectangular shape.

The reagent bottle 110 is a bottle that stores a reagent. The opening member 111 is a hollow member formed through an opening into which the first reagent dispensing probe 209 (see FIG. 2) is inserted. The main body 112 is a hollow member that stores a reagent. The opening member 111 and the main body 112 may be integrally molded.

The adapter 120 is an instrument detachably attached to the reagent bottle 110. The adapter 120 is attached from the lower surface of the reagent bottle 110. The frame body 121 is a member having a shape conforming to the reagent bottle 110. The engaging claw 122 is an inverted L-shaped member protruding from the left side surface of the frame body 121. The engaging claw 122 is engaged by the reagent container arm 220. The cutout surface 123 is a surface inclined from the left side surface to the lower surface of the frame body 121. The shape of the cutout surface 123 corresponds to the shape of the inclined surface of the inclined member 328.

The fitting groove 130 is a groove having a shape corresponding to the outer circumferential rail 315 and the inner circumferential rail 325. The reagent container 100 is fitted to the outer circumferential rail 315 and the inner circumferential rail 325 by the fitting groove 130 formed in the lower surface of the adapter 120.

In a case where the adapter 120 is not attached to the reagent bottle 110, the fitting groove 130 may be formed in the lower surface of the reagent bottle 110. In this case, the reagent container 100 is regarded as the same as the reagent bottle 110. That is, the reagent container 100 (reagent bottle 110) is fitted to the outer circumferential rail 315 and the inner circumferential rail 325 by the fitting groove 130 formed in the lower surface.

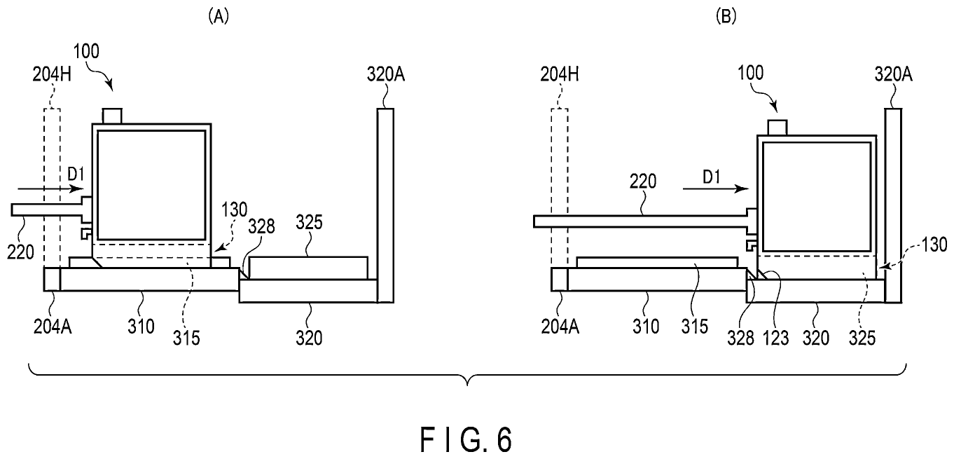

FIG. 6 is a view illustrating an example in which the reagent container 100 according to the first embodiment is conveyed to the inner circumferential table 320. FIG. 6 (A) is a front view illustrating a state where the reagent container 100 is conveyed to the outer circumferential table 310. FIG. 6 (B) is a front view illustrating a state where the reagent container 100 is conveyed to the inner circumferential table 320.

As illustrated in FIG. 6 (A), the reagent container arm 220 conveys the reagent container 100 along the direction D1 while being in contact with the left side surface of the reagent container 100. At this time, the fitting groove 130 of the reagent container 100 is fitted to the outer circumferential rail 315 with a certain margin. By fitting, the reagent container arm 220 can accurately and smoothly convey the reagent container 100 along a direction in which the outer circumferential rail 315 extends.

As illustrated in FIG. 6 (B), the reagent container arm 220 conveys the reagent container 100 conveyed to the outer circumferential table 310 to the inner circumferential table 320 along the direction D1. At the step between the outer circumferential table 310 and the inner circumferential table 320, the reagent container 100 slides down the inclined surface of the inclined member 328 via the cutout surface 123. At the same time, the fitting groove 130 of the reagent container 100 is fitted to the inner circumferential rail 325 with little margin. By fitting, the reagent container arm 220 can accurately and smoothly convey the reagent container 100 along a direction in which the inner circumferential rail 325 extends.

Due to the rotation of the inner circumferential table 320, a centrifugal force is applied in a direction opposite to the direction D1 to the reagent container 100 conveyed to the inner circumferential table 320. At this time, the step between the outer circumferential table 310 and the inner circumferential table 320 prevents the reagent container 100 from being pushed back to the outer circumferential table 310 by the centrifugal force. That is, the step can fix the reagent container 100 to the inner circumferential table 320.

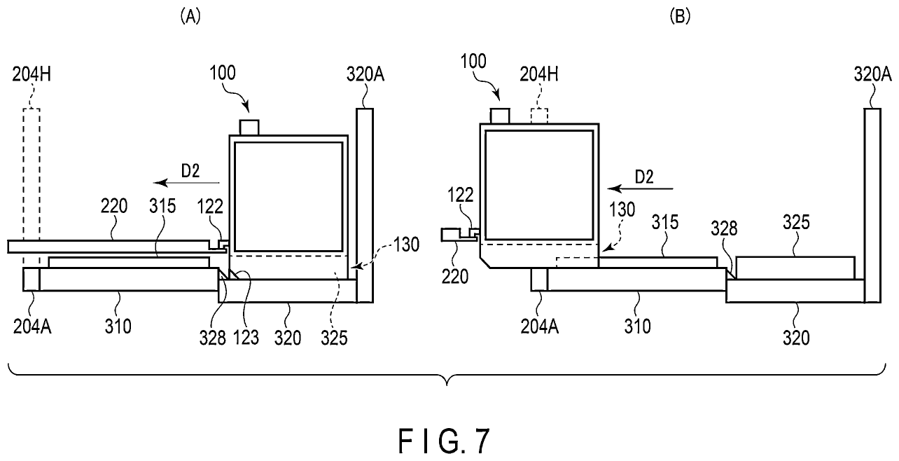

FIG. 7 is a view illustrating an example in which the reagent container 100 according to the first embodiment is conveyed from the inner circumferential table 320. FIG. 7 (A) is a front view illustrating a state where the reagent container 100 is conveyed to the inner circumferential table 320. FIG. 7 (B) is a front view illustrating a state where the reagent container 100 is conveyed to the outer circumferential table 310.

As illustrated in FIG. 7 (A), the reagent container arm 220 conveys the reagent container 100 along a direction D2 opposite to the direction D1 while being engaged with the engaging claw 122 of the reagent container 100. At the step between the outer circumferential table 310 and the inner circumferential table 320, the reagent container 100 slides up the inclined surface of the inclined member 328 via the cutout surface 123. At the same time, the fitting groove 130 of the reagent container 100 is fitted to the outer circumferential rail 315 with a certain margin. By fitting, the reagent container arm 220 can accurately and smoothly convey the reagent container 100 along a direction in which the outer circumferential rail 315 extends.

As illustrated in FIG. 7 (B), the reagent container arm 220 conveys the reagent container 100 along the direction D2 while being engaged with the engaging claw 122 of the reagent container 100. The reagent container arm 220 conveys the reagent container 100 to the outside of the first reagent storage 204 through the opening 204H.

According to the first embodiment described above, the automatic analysis apparatus 1 conveys the reagent container 100 not from “above” but from “side” of the first reagent storage 204. Specifically, the automatic analysis apparatus 1 conveys the reagent container 100 held by the reagent container arm 220 into the first reagent storage 204 through the opening 204H formed in the housing 204A of the first reagent storage 204. Meanwhile, the automatic analysis apparatus 1 conveys the reagent container 100 held by the reagent container arm 220 to the outside of the first reagent storage 204 through the opening 204H.

That is, the automatic analysis apparatus 1 pushes out or pulls out the reagent container 100 held by the reagent container arm 220 in the horizontal direction through the opening 204H. At this time, since the reagent container arm 220 does not need to move in the vertical direction, the operation control or structure of the reagent container arm 220 is simplified. Therefore, the automatic analysis apparatus 1 can reduce the cost of the entire device including the reagent container arm 220.

### Modified Example of First Embodiment

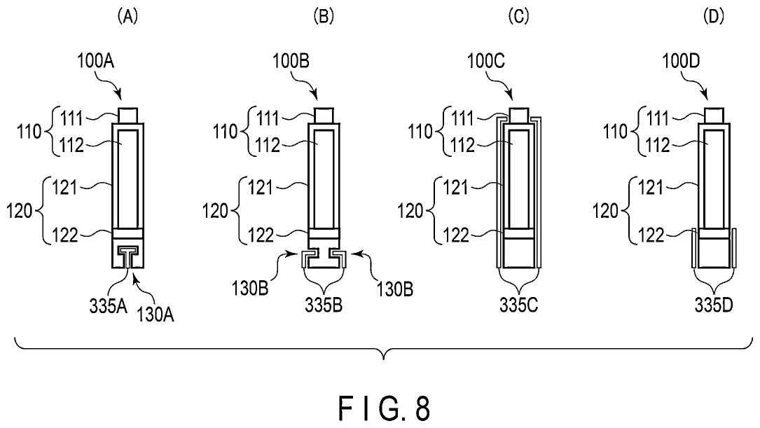

FIG. 8 is a view illustrating the configuration example of reagent containers (100A, 100B, 100C, 100D) and rails (335A, 335B, 335C, 335D) according to Modified Example of the first embodiment. FIG. 8 (A) is a left side view of the reagent container 100A and the rail 335A. FIG. 8 (B) is a left side view of the reagent container 100B and the rail 335B. FIG. 8 (C) is a left side view of the reagent container 100C and the rail 335C. FIG. 8 (D) is a left side view of the reagent container 100D and the rail 335D.

As illustrated in FIG. 8 (A), a T-shaped fitting groove 130A is formed in the lower portion of the reagent container 100A. The rail 335A has a T-shape so as to correspond to the shape of the fitting groove 130A. The rail 335A is an example of an outer circumferential rail 315 or an inner circumferential rail 325.

A reagent container arm 220 conveys the reagent container 100A while fitting the fitting groove 130A of the reagent container 100A to the rail 335A. At this time, the movement of the reagent container 100A is restricted by the shape of the rail 335A so as not to swing not only in the horizontal direction but also in the vertical direction. Therefore, the reagent container arm 220 can more stably convey the reagent container 100A along a direction in which the rail 335A extends. According to another aspect, the T-shaped fitting groove 130A and the rail 335A can prevent the foaming of the reagent stored in the reagent container 100A caused by the swinging of the reagent container 100A.

As illustrated in FIG. 8 (B), a pair of rectangular fitting grooves 130B are formed in the lower portion of the reagent container 100B. One fitting groove 130B has a shape laterally inverted with respect to the other fitting groove 130B. The pair of rails 335B have an inverted L shape so as to be fitted in the pair of fitting grooves 130B. The rail 335B is an example of an outer circumferential rail 315 or an inner circumferential rail 325.

The reagent container arm 220 conveys the reagent container 100B while fitting the pair of fitting grooves 130B of the reagent container 100B to the pair of rails 335B. At this time, the movement of the reagent container 100B is restricted by the shape of the pair of rails 335B so as not to swing not only in the horizontal direction but also in the vertical direction. Therefore, the reagent container arm 220 can more stably convey the reagent container 100B along a direction in which the pair of rails 335B extend. According to another aspect, the pair of rectangular fitting grooves 130B and the pair of inverted L-shaped rail 335B can prevent the foaming of the reagent stored in the reagent container 100B caused by the swinging of the reagent container 100B.

As illustrated in FIG. 8 (C), unlike the reagent container 100, the fitting groove 130 is not formed in the reagent container 100C. Each of the pair of rails 335C has an inverted L shape so as to sandwich the reagent container 100C from the horizontal direction. In particular, a part of the pair of rails 335C are disposed so as to cover the upper surface of a main body 112 (frame body 121). The rail 335C is an example of the outer circumferential rail 315 or the inner circumferential rail 325.

The reagent container arm 220 conveys the reagent container 100C through between the pair of rails 335C. At this time, the movement of the reagent container 100C is restricted by the shape of the pair of rails 335C so as not to swing not only in the horizontal direction but also in the vertical direction. Therefore, the reagent container arm 220 can more stably convey the reagent container 100C along a direction in which the pair of rails 335C extend. According to another aspect, the pair of rails 335C can prevent the foaming of the reagent stored in the reagent container 100C caused by the swinging of the reagent container 100C.

As illustrated in FIG. 8 (D), unlike the reagent container 100, the fitting groove 130 is not formed in the reagent container 100D. The pair of rails 335D are disposed so as to sandwich the lower portion of the reagent container 100D from the horizontal direction. The rail 335D is an example of the outer circumferential rail 315 or the inner circumferential rail 325.

The reagent container arm 220 conveys the reagent container 100D through between the pair of rails 335D. At this time, the movement of the reagent container 100D is restricted by the shape of the pair of rails 335D so as not to swing in the horizontal direction. Therefore, the reagent container arm 220 can stably convey the reagent container 100D along a direction in which the pair of rails 335D extend. According to another aspect, the pair of rails 335D can prevent the foaming of the reagent stored in the reagent container 100D caused by the swinging of the reagent container 100D.

The pair of rails 335D illustrated in FIG. 8 (D) restrict the swinging of the reagent container 100D in the horizontal direction. Meanwhile, fitting between the fitting groove 130 illustrated in FIG. 5 (A) and the outer circumferential rail 315 or the inner circumferential rail 325 restricts the swinging of the reagent container 100 in the horizontal direction. That is, the pair of rails 335D exhibit the same effects as those of the fitting between the fitting groove 130 and the outer circumferential rail 315 or the inner circumferential rail 325.

### Second Embodiment

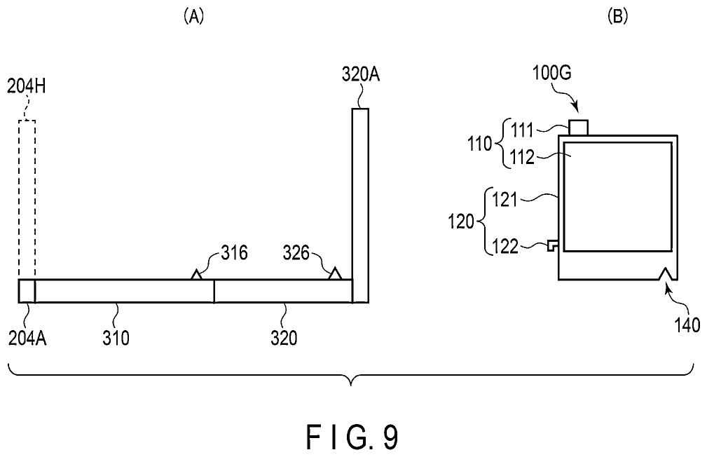

FIG. 9 is a view illustrating the configuration example of each table and reagent container 100G according to a second embodiment. FIG. 9 (A) is a front view of an outer circumferential table 310 and an inner circumferential table 320. FIG. 9 (B) is a front view of the reagent container 100G.

As illustrated in FIG. 9 (A), the outer circumferential table 310 includes a projection member 316 at one end adjacent to the inner circumferential table 320. The inner circumferential table 320 includes a projection member 326 at one end adjacent to an inner wall 320A. The projection members 316 and 326 have the same shape (for example, triangular, semicircular). The projection members 316 and 326 are formed to have a predetermined size so that the reagent container 100G rides on and is fitted to the projection members 316 and 326.

As illustrated in FIG. 9 (B), a fitting groove 140 is formed on the lower surface of the reagent container 100G near the right side surface. The fitting groove 140 has a shape corresponding to the projection members 316 and 326.

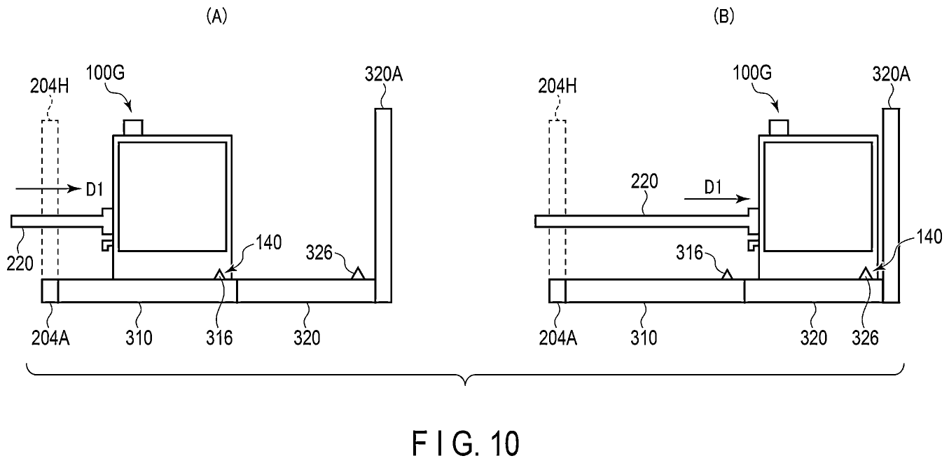

FIG. 10 is a view illustrating an example in which the reagent container 100G according to the second embodiment is conveyed to each table. FIG. 10 (A) is a front view illustrating a state where the reagent container 100G is conveyed to the outer circumferential table 310. FIG. 10 (B) is a front view illustrating a state where the reagent container 100G is conveyed to the inner circumferential table 320.

As illustrated in FIG. 10 (A), the reagent container arm 220 conveys the reagent container 100G along a direction D1 while being in contact with the left side surface of the reagent container 100G. At this time, the fitting groove 140 of the reagent container 100G rides on and is fitted to the projection member 316. The reagent container 100G is fixed to the outer circumferential table 310 by fitting.

Due to the rotation of the outer circumferential table 310, a centrifugal force is applied in a direction opposite to the direction D1 to the reagent container 100G conveyed to the outer circumferential table 310. At this time, the fitting between the fitting groove 140 and the projection member 316 prevents the reagent container 100G from being pushed back to the outside through an opening 204H by the centrifugal force. That is, the fitting can fix the reagent container 100G to the outer circumferential table 310.

As illustrated in FIG. 10 (B), the reagent container arm 220 conveys the reagent container 100G fixed to the outer circumferential table 310 to the inner circumferential table 320 along the direction D1. At this time, the fitting groove 140 of the reagent container 100G removes the fitting to the projection member 316, and rides on and is fitted to the projection member 326. The reagent container 100G is fixed to the inner circumferential table 320 by fitting.

Due to the rotation of the inner circumferential table 320, a centrifugal force is applied in a direction opposite to the direction D1 to the reagent container 100G conveyed to the inner circumferential table 320. At this time, the fitting between the fitting groove 140 and the projection member 326 prevents the reagent container 100G from being pushed back to the outer circumferential table 310 by the centrifugal force. That is, the fitting can fix the reagent container 100G to the inner circumferential table 320.

The reagent container 100G according to the second embodiment is conveyed to the outside of the first reagent storage 204 by the same method as in the first embodiment. That is, the reagent container arm 220 conveys the reagent container 100G along a direction D2 opposite to the direction D1 while being engaged with an engaging claw 122 of the reagent container 100G (see FIG. 7).

According to the second embodiment described above, an automatic analysis apparatus 1 exhibits the same effects as those of the first embodiment. Furthermore, the automatic analysis apparatus 1 can fix the reagent container 100G to the outer circumferential table 310 or the inner circumferential table 320 by fitting the fitting groove 140 of the reagent container 100G to the projection member 316 or 326.

### Third Embodiment

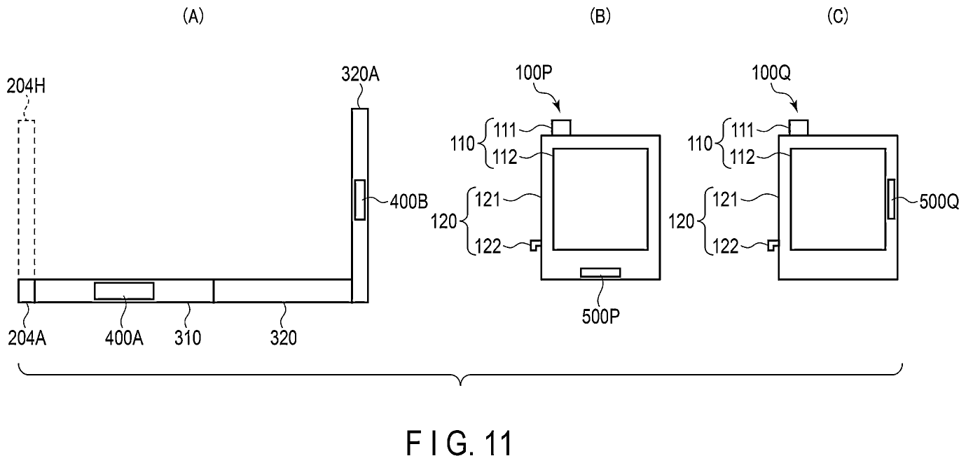

FIG. 11 is a view illustrating the configuration example of each table and each reagent container according to a third embodiment. FIG. 11 (A) is a front view of an outer circumferential table 310 and an inner circumferential table 320. FIG. 11 (B) is a front view of a reagent container 100P (first reagent container). FIG. 11 (C) is a front view of a reagent container 100Q (second reagent container).

As illustrated in FIG. 11 (A), the outer circumferential table 310 includes a magnet 400A (first magnet). The magnet 400A is disposed at the center of the outer circumferential table 310. An inner wall 320A includes a magnet 400B (second magnet). The magnet 400B is disposed at the center of the inner wall 320A.

As illustrated in FIG. 11 (B), a magnetic body 500P (first magnetic body) is disposed at the center of the lower surface of the reagent container 100P. The magnetic body 500P may be a member formed of an electromagnetic material such as iron, cobalt, or nickel. Typically, the magnetic body 500P is an iron plate.

As illustrated in FIG. 11 (C), a magnetic body 500Q (second magnetic body) is disposed at the center of the right side surface of the reagent container 100Q. The magnetic body 500Q may be a member formed of an electromagnetic material such as iron, cobalt, or nickel. Typically, the magnetic body 500Q is an iron plate.

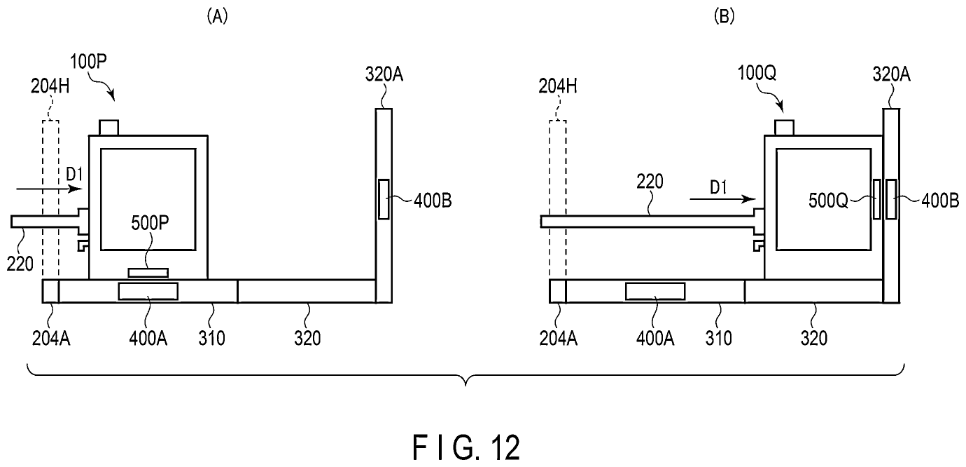

FIG. 12 is a view illustrating an example in which each reagent container is conveyed to each table according to the third embodiment. FIG. 12 (A) is a front view illustrating a state where the reagent container 100P is conveyed to the outer circumferential table 310. FIG. 12 (B) is a front view illustrating a state where the reagent container 100Q is conveyed to the inner circumferential table 320.

As illustrated in FIG. 12 (A), the reagent container arm 220 conveys the reagent container 100P along a direction D1 while being in contact with the left side surface of the reagent container 100P. At this time, a magnetic attraction force is generated between the magnet 400A of the outer circumferential table 310 and the magnetic body 500P of the reagent container 100P. The reagent container 100P is fixed to the outer circumferential table 310 by the attraction force.

Due to the rotation of the outer circumferential table 310, a centrifugal force is applied in a direction opposite to the direction D1 to the reagent container 100P conveyed to the outer circumferential table 310. At this time, the attraction between the magnet 400A and the magnetic body 500P prevents the reagent container 100P from being pushed back to the outside through an opening 204H by the centrifugal force. That is, the attraction can fix the reagent container 100P to the outer circumferential table 310.

As illustrated in FIG. 12 (B), the reagent container arm 220 conveys the reagent container 100Q along the direction D1 while being in contact with the left side surface of the reagent container 100Q. At this time, a magnetic attraction force is generated between the magnet 400B of the inner wall 320A and the magnetic body 500Q of the reagent container 100Q. The reagent container 100Q is fixed to the inner circumferential table 320 adjacent to the inner wall 320A by the attraction force.

Due to the rotation of the inner circumferential table 320, a centrifugal force is applied in a direction opposite to the direction D1 to the reagent container 100Q conveyed to the inner circumferential table 320. At this time, the attraction between the magnet 400B and the magnetic body 500Q prevents the reagent container 100Q from being pushed back to the outer circumferential table 310 by the centrifugal force. That is, the attraction can fix the reagent container 100Q to the inner circumferential table 320.

The reagent containers 100P and 100Q according to the third embodiment are conveyed to the outside of a first reagent storage 204 by the same method as in the first embodiment. That is, the reagent container arm 220 conveys the reagent container 100P along a direction D2 opposite to the direction D1 while being engaged with an engaging claw 122 of the reagent container 100P. The reagent container arm 220 conveys the reagent container 100Q along the direction D2 while being engaged with an engaging claw 122 of the reagent container 100Q (see FIG. 7).

Here, it is assumed that the reagent container arm 220 conveys the reagent container 100Q fixed to the inner circumferential table 320 along the direction D2. In this case, the reagent container arm 220 peels off the magnetic body 500Q attracted to the magnet 400B along the direction D2. Subsequently, the reagent container arm 220 conveys the reagent container 100Q to the outside of the first reagent storage 204 through the outer circumferential table 310.

In a case where the reagent container 100Q passes over the outer circumferential table 310, a certain distance is maintained between the magnet 400A of the outer circumferential table 310 and the magnetic body 500Q of the reagent container 100Q. This distance is larger than a distance between the magnet 400A of the outer circumferential table 310 and the magnetic body 500P of the reagent container 100P. Therefore, the reagent container 100Q is smoothly conveyed without being rarely attracted to the magnet 400A as compared with the reagent container 100P.

Similarly to the outer circumferential table 310, the inner circumferential table 320 may include the magnet 400B at the center. In this case, similarly to the reagent container 100P, the reagent container 100Q may include the magnetic body 500Q at the center of the lower surface. That is, the reagent container 100Q may have the same configuration as that of the reagent container 100P.

In the above case, the reagent container arm 220 conveys the reagent container 100Q to the inner circumferential table 320 while being in contact with the left side surface of the reagent container 100Q. At this time, a magnetic attraction force is generated between the magnet 400B of the inner circumferential table 320 and the magnetic body 500Q of the reagent container 100Q. The reagent container 100Q is fixed to the inner circumferential table 320 by the attraction force.

According to the third embodiment described above, an automatic analysis apparatus 1 exhibits the same effects as those of the first embodiment. Furthermore, in the automatic analysis apparatus 1, the reagent container 100P can be fixed to the outer circumferential table 310 by the attraction force between the magnet 400A of the outer circumferential table 310 and the magnetic body 500P of the reagent container 100P. In the automatic analysis apparatus 1, the reagent container 100Q can be fixed to the inner circumferential table 320 by the attraction force between the magnet 400B of the inner wall 320A and the magnetic body 500Q of the reagent container 100Q.

### Each Embodiment

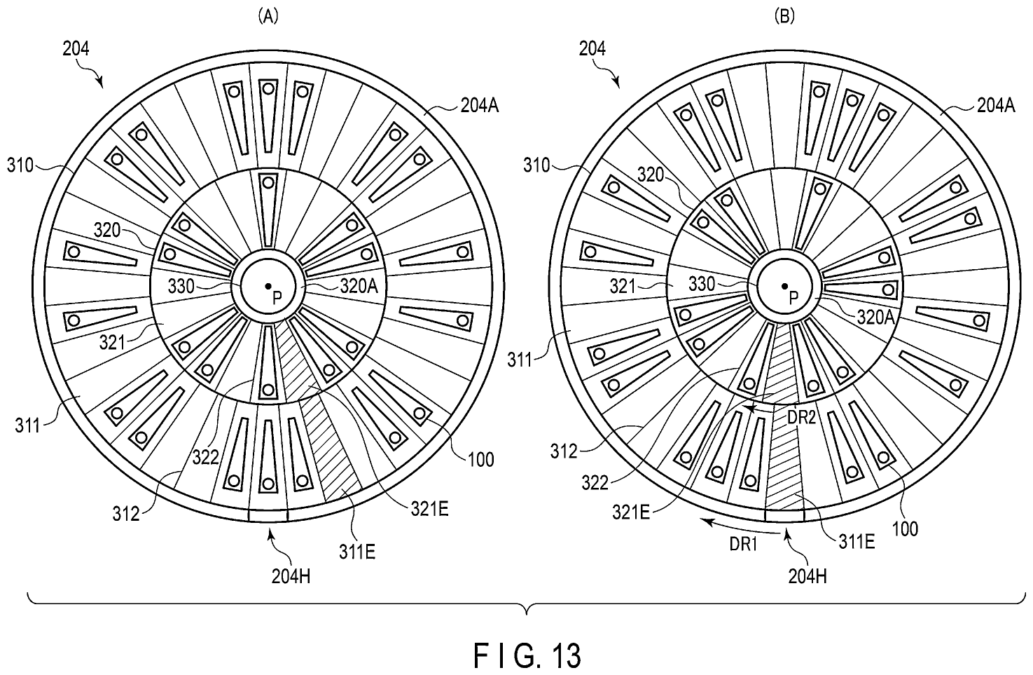

FIG. 13 is a top view illustrating the rotation control example of each table according to each embodiment. FIG. 13 (A) is a top view of an outer circumferential table 310 and an inner circumferential table 320 before rotation. FIG. 13 (B) is a top view of the outer circumferential table 310 and the inner circumferential table 320 after rotation.

As illustrated in FIG. 13 (A), in the outer circumferential table 310 and the inner circumferential table 320, a plurality of reagent containers 100 are disposed at equal intervals on a circumference around a rotation center P. In other words, the plurality of reagent containers 100 are disposed point-symmetrically with respect to the rotation center P. By the disposing, a load is uniformly applied to each position of the outer circumferential table 310 or the inner circumferential table 320. Therefore, the disposing can reduce vibration accompanying the rotation of the outer circumferential table 310 or the inner circumferential table 320.

Here, two reagent containers 100 are disposed in a direction D1 (see FIG. 3) from an opening 204H toward the rotation center P. Specifically, in the direction D1, the reagent container 100 is disposed in a space 311 of the outer circumferential table 310, and the other reagent container 100 is disposed in a space 321 of the inner circumferential table 320. In this case, an automatic analysis apparatus 1 needs to rotate each of the outer circumferential table 310 and the inner circumferential table 320 in order to convey the reagent container 100 to the empty space 321 of the inner circumferential table 320.

For example, the automatic analysis apparatus 1 causes a specific function 91 to specify the empty space 311 in the outer circumferential table 310 closest to the position of the opening 204H. In a case where the outer circumferential table 310 rotates clockwise, the specific function 91 specifies a space 311E as the empty space 311.

Similarly, the automatic analysis apparatus 1 causes the specific function 91 to specify the empty space 321 in the inner circumferential table 320 closest to the position of the opening 204H. In a case where the inner circumferential table 320 rotates clockwise, the specific function 91 specifies a space 321E as the empty space 321.

Subsequently, the automatic analysis apparatus 1 causes a system control function 92 and a drive mechanism 4 to rotate the outer circumferential table 310 so that the space 311E specified by the specific function 91 approaches (is adjacent to) the position of the opening 204H.

Similarly, the automatic analysis apparatus 1 causes the system control function 92 and the drive mechanism 4 to rotate the inner circumferential table 320 so that the space 321E specified by the specific function 91 approaches (is adjacent to) the position of the opening 204H.

As illustrated in FIG. 13 (B), the automatic analysis apparatus 1 rotates the outer circumferential table 310 in a direction DR1 and rotates the inner circumferential table 320 in a direction DR2. The spaces 311E and 321E are located in the direction D1 by the rotation of each table. The automatic analysis apparatus 1 causes a reagent container arm 220 to convey the reagent container 100 to the space 321E through the opening 204H and the space 311E.

With the above operation, the automatic analysis apparatus 1 minimizes a rotation distance (rotation angle) between the outer circumferential table 310 and the inner circumferential table 320. Therefore, the automatic analysis apparatus 1 can quickly convey the reagent container 100 held by the reagent container arm 220 to the empty space 321 of the inner circumferential table 320. Furthermore, the automatic analysis apparatus 1 can prevent the foaming of the reagent stored in the plurality of reagent containers 100 with respect to the plurality of reagent containers 100 loaded on the outer circumferential table 310 or the inner circumferential table 320.

### Other Modified Examples

First, an automatic analysis apparatus 1 may rotate an outer circumferential table 310 or an inner circumferential table 320 so as to bring a predetermined empty space 311 or 321 selected by an operator via an input IF 6 close to the position of an opening 204H. In this case, the automatic analysis apparatus 1 can transport the reagent container 100 to the empty space 311 or 321 desired by the operator.

Secondly, the automatic analysis apparatus 1 may specify a distance from the position of the opening 204H to a space 311E or 321E by a specific function 91. The distance may be a “linear distance” from the position of the opening 204H to the space 311E or 321E.

Alternatively, the distance may be a “rotation distance” (rotation angle) of the outer circumferential table 310 or the inner circumferential table 320 necessary for bringing the space 311E or 321E close to the position of the opening 204H.

In this case, the automatic analysis apparatus 1 may cause a system control function 92 and a drive mechanism 4 to change a speed at which the outer circumferential table 310 or the inner circumferential table 320 is rotated according to the distance. For example, the automatic analysis apparatus 1 increases the rotation speed of the outer circumferential table 310 or the inner circumferential table 320 as the distance is shorter. As a result, the automatic analysis apparatus 1 can quickly bring the space 311E or 321E relatively close to the position of the opening 204H close to the position of the opening 204H. Meanwhile, the automatic analysis apparatus 1 can bring the space 311E or 321E relatively far from the position of the opening 204H close to the position of the opening 204H so that the reagent stored in each reagent container 100 does not foam.

Thirdly, the automatic analysis apparatus 1 may cause the specific function 91 to specify the empty space 311 or 321 (loading space) in which the reagent containers 100 can be loaded so that the plurality of reagent containers 100 are loaded at equal intervals on a circumference on the outer circumferential table 310 or the inner circumferential table 320. For example, the specific function 91 specifies whether or not a pair of reagent containers 100 are disposed for the pair of spaces 311 or 321 disposed point-symmetrically with respect to a rotation center P. In a case where, with respect to the specific pair of spaces 311 or 321, the reagent container 100 is loaded only in one space 311, the specific function 91 specifies the other space 311 as the empty space 311 or 321.

In this case, the automatic analysis apparatus 1 causes the reagent container arm 220 to convey the reagent container 100 to the empty space 311 or 321. As a result, the automatic analysis apparatus 1 can dispose the plurality of reagent containers 100 at equal intervals on the outer circumferential table 310 or the inner circumferential table 320. That is, the automatic analysis apparatus 1 exhibits the effects described above (see FIG. 13 (A)).

Fourthly, the automatic analysis apparatus 1 may cause the reagent container arm 220 to convey the reagent container 100 to the inner circumferential table 320 while lifting the reagent container 100 without placing the reagent container 100 on the outer circumferential table 310. That is, the reagent container arm 220 may place the lifted reagent container 100 on the inner circumferential table 320 without contacting the outer circumferential table 310.

Fifthly, the outer circumferential table 310 may have at least one empty space for not loading the reagent container 100. The empty space may be formed in a straight path shape. The empty spaces may be formed at equal intervals on the circumference of the outer circumferential table 310. Specifically, for an angle θ (°) around the rotation center P, the empty space may be formed at θ/360 (place) for each angle θ. For example, in cases of angle θ=180, 120, 90, the empty spaces are formed at equal intervals at 2, 3, and 4 locations, respectively. The automatic analysis apparatus 1 may cause the reagent container arm 220 to convey the reagent container 100 to the inner circumferential table 320 through the empty space formed in the outer circumferential table 310.

Assume a case where the outer circumferential table 310 has only a plurality of spaces for loading the reagent containers 100, and the reagent containers 100 are loaded in all of the plurality of spaces. In this case, since there is no empty space in the outer circumferential table 310, the reagent container arm 220 cannot convey the reagent container 100 to the inner circumferential table 320 through the empty space.

Meanwhile, in a case where the outer circumferential table 310 has at least one empty space for not loading the reagent container 100, the reagent container arm 220 can convey the reagent container 100 to the inner circumferential table 320 through the empty space. That is, since the outer circumferential table 310 has a dedicated empty space for conveying the reagent container 100 to the inner circumferential table 320, the reagent container 100 can freely move between the outer circumferential table 310 and the inner circumferential table 320.

According to at least one embodiment described above, the structure of the automatic analysis apparatus can be simplified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analysis apparatus comprising:
a reagent storage including an outer circumferential table on which a plurality of reagent containers are loaded and an inner circumferential table located inside the outer circumferential table and on which a plurality of reagent containers are loaded; and
a reagent container arm that conveys a reagent container to the inner circumferential table through between the reagent containers loaded on the outer circumferential table.

2. The automatic analysis apparatus according to claim 1, wherein the outer circumferential table has a plurality of spaces for loading reagent containers, and the reagent container arm conveys the reagent container to the inner circumferential table through an empty space where no reagent container is loaded among the spaces.

3. The automatic analysis apparatus according to claim 1, wherein at least one of the outer circumferential table and the inner circumferential table includes a guide portion extending in a radial direction of the reagent storage, and the reagent container arm conveys the reagent container via the guide portion.

4. The automatic analysis apparatus according to claim 3, wherein the guide portion is a rail, and a fitting groove corresponding to the rail is formed in the reagent container.

5. The automatic analysis apparatus according to claim 3, wherein the outer circumferential table includes, as the guide portion, an outer circumferential rail extending in a radial direction of the outer circumferential table in at least a space in which the reagent container is loaded, the inner circumferential table includes, as the guide portion, an inner circumferential rail extending in a radial direction of the inner circumferential table in each space in which the reagent container is loaded, and a fitting groove corresponding to the outer circumferential rail and the inner circumferential rail is formed in the reagent container.

6. The automatic analysis apparatus according to claim 5, wherein the reagent container arm sequentially fits the outer circumferential rail and the inner circumferential rail to the fitting groove, and conveys the reagent container to the inner circumferential table through the outer circumferential table.

7. The automatic analysis apparatus according to claim 3, wherein the guide portion is a rail, and a fitting groove corresponding to the rail is formed in an adapter attached to the reagent container.

8. The automatic analysis apparatus according to claim 3, wherein the guide portion is a partition wall, and the reagent container is supported by the partition wall.

9. The automatic analysis apparatus according to claim 1, wherein the outer circumferential table includes a magnet, the reagent container includes a magnetic body, and the reagent container arm fixes the reagent container to the outer circumferential table by an attraction force between the magnet and the magnetic body by conveying the reagent container to the outer circumferential table.

10. The automatic analysis apparatus according to claim 1, wherein the inner circumferential table includes a magnet, the reagent container includes a magnetic body, and the reagent container arm fixes the reagent container to the inner circumferential table by an attraction force between the magnet and the magnetic body by conveying the reagent container to the inner circumferential table.

11. The automatic analysis apparatus according to claim 1, wherein the inner circumferential table includes an inner wall at one end not adjacent to the outer circumferential table, the outer circumferential table includes a first magnet, the inner wall includes a second magnet, a first reagent container loaded on the outer circumferential table includes a first magnetic body, a second reagent container loaded on the inner circumferential table includes a second magnetic body, and the reagent container arm conveys the first reagent container to the outer circumferential table to fix the first reagent container to the outer circumferential table by an attraction force between the first magnet and the first magnetic body, and conveys the second reagent container to the inner circumferential table to fix the second reagent container to the inner circumferential table by an attraction force between the second magnet and the second magnetic body.

12. The automatic analysis apparatus according to claim 1, wherein the reagent storage includes a housing adjacent to the outer circumferential table and having an opening into which the reagent container can be inserted, and the automatic analysis apparatus further comprises:
a control circuit that specifies an empty space closest to a position of the opening and in which the reagent container is not loaded on the outer circumferential table; and
a drive mechanism that rotates the outer circumferential table so that the empty space is adjacent to the opening.

13. The automatic analysis apparatus according to claim 12, wherein the control circuit specifies a distance from the position of the opening to the empty space, and the drive mechanism changes a speed at which the outer circumferential table is rotated according to the distance.

14. The automatic analysis apparatus according to claim 12, wherein the control circuit specifies a loading space of the reagent container so that the reagent containers are loaded at equal intervals on a circumference of the outer circumferential table, and the reagent container arm conveys the reagent container to the loading space.

15. The automatic analysis apparatus according to claim 1, further comprising a reagent container rack on which the reagent container is placed, adjacent to the reagent storage, wherein the reagent container arm holds the reagent container placed on the reagent container rack, and conveys the held reagent container to the inner circumferential table through between the reagent containers loaded on the outer circumferential table.

16. The automatic analysis apparatus according to claim 1, wherein the reagent container arm conveys the reagent container loaded on the inner circumferential table to the outside of the reagent storage through between the reagent containers loaded on the outer circumferential table.

17. The automatic analysis apparatus according to claim 1, wherein the outer circumferential table has an empty space for not loading reagent containers, and the reagent container arm conveys the reagent container to the inner circumferential table through the empty space.

18. A method for controlling an automatic analysis apparatus comprising:
a reagent storage including an outer circumferential table on which a plurality of reagent containers are loaded and an inner circumferential table located inside the outer circumferential table and on which a plurality of reagent containers are loaded; and
a reagent container arm that conveys a reagent container into the reagent storage, wherein the reagent storage and the reagent container arm are controlled to convey a reagent container to the inner circumferential table through between the reagent containers loaded on the outer circumferential table.
